(19) United States
(12) Patent Application Publication
(10) Pub. No.: US 2026/0088650 A1
(43) Pub. Date: Mar. 26, 2026

(54) STANDARDIZED MICROGRID INTERFACING

(71) Applicant: QSecGrid, Inc., New York, NY (US)

(72) Inventors: Gordon R. WINSTON, Katonah, NY (US); John-Philip GALINSKI, Forest Hills, NY (US); Nigel WALKER, Ponteland (GB); Mark THOMPSON, Blyth (GB); Patrick J.D. SANTOS, Kirkland, WA (US)

(21) Appl. No.: 19/274,055

(22) Filed: Jul. 18, 2025

Related U.S. Application Data
(60) Provisional application No. 63/699,116, filed on Sep. 25, 2024.

(51) Int. Cl. H02J 13/00; H02J 3/00; H02J 3/24; H02J 3/38

(52) U.S. Cl. CPC H02J 13/10; H02J 3/0014; H02J 3/003; H02J 3/004; H02J 3/381; H02J 2103/30; H02J 2103/35

(57) ABSTRACT

Systems for microgrid interfacing may include a virtual resource platform (VRP) for integration and management of a plurality of integrated distributed energy resources (IDERs). The VRP may include at least one request-handling interface to process requests for interfacing IDERs, a driver identification engine to retrieve resource metadata attributes and identify compatible drivers, and a standardized application programming interface (API) for cross-platform compatibility. The VRP may further include a predictive energy manager. The predictive energy manager may fetch telemetry data from the IDERs, analyze the data using machine-learning-based models, and may generate energy management analysis products.

### RELATED APPLICATION

This application claims priority to a commonly owned, U.S. Provisional Patent Application No. 63/699,116, filed on Sep. 25, 2024, and titled “Predictive Energy Management”, which is herein incorporated by reference in its entirety.

### TECHNICAL FIELD

Embodiments of the present invention generally relate to managing energies, and more particularly to energy management with microgrid interfacing.

### BACKGROUND

Energy is a fundamental resource that powers economies, industries, and daily life. Traditionally, electrical power has been generated through centralized power plants and transmitted via extensive networks to end users. However, as energy demand continues to grow and environmental concerns increase, the focus is shifting towards more sustainable and decentralized methods of energy generation. This shift is primarily driven by the adoption of renewable energy sources such as solar, wind, and hydropower, which offer the potential for cleaner, more efficient, and localized energy production.

The integration of renewable energy into a traditional power grid presents challenges due to the intermittent and variable nature of renewable resources. To address these challenges and improve energy resilience, microgrids have emerged as a promising solution. A microgrid is a localized energy system that can operate independently or in parallel with a main grid. The microgrid integrates various energy sources, including renewable energy resources, Energy Storage Systems (ESS), and conventional power generation for efficient energy management within a defined geographic area.

Microgrids are especially beneficial in remote or underserved areas where access to the main grid is limited or unreliable. By operating autonomously or islanded, microgrids can ensure continuous power supply during grid outages or periods of peak demand. In addition, microgrids can contribute to the optimization of energy use by providing real-time management of energy resources, improving energy efficiency, and reducing reliance on fossil fuels.

However, despite several advantages of the microgrids, deployment, and operation of the microgrids are not without challenges. The integration of multiple, diverse energy sources, including renewable energy generation and storage, requires advanced systems for managing power conversion, distribution, and storage. Additionally, it may be desirable for microgrids to have an ability to seamlessly coordinate energy flows between generation, storage, and consumption, while accounting for fluctuations in both energy demand and energy resource availability. Many conventional microgrid systems are limited by their reliance on proprietary communication protocols or closed-loop systems, which hinder scalability and interoperability with new devices or technologies. This lack of standardization between devices and systems impedes the development of more robust and adaptable microgrids, limiting their potential to scale efficiently or integrate with broader smart grid networks.

There is thus a need for more efficient and/or effective microgrid interfacing.

### BRIEF DESCRIPTION OF THE DRAWINGS

Features and advantages of embodiments of the present invention will become apparent upon consideration of the following detailed description of embodiments thereof, especially when taken in conjunction with the accompanying drawings, in which:

FIG. 1 is a block diagram depicting an exemplary computing environment for microgrid interfacing in accordance with at least one embodiment of the present invention.

FIG. 2 is an exemplary functional block diagram of components of microgrid interfacing in accordance with at least one embodiment of the present invention.

FIG. 3 is an exemplary table of resource metadata attributes of Integrated Distributed Energy Resources (IDERs) in accordance with at least one embodiment of the present invention.

FIG. 4 is an exemplary functional block diagram of a Virtual Resource Platform (VRP) in accordance with at least one embodiment of the present invention.

FIG. 5 is an exemplary table of system parameters of the IDERs in accordance with at least one embodiment of the present invention.

FIG. 6 is an exemplary process of interfacing a new IDER with the VRP in accordance with at least one embodiment of the present invention.

FIG. 7 is an exemplary process of managing telemetry data of the IDER in accordance with at least one embodiment of the present invention.

FIG. 8 is an exemplary process of handling a shutdown of the IDER in accordance with at least one embodiment of the present invention.

FIG. 9 is an exemplary process of providing energy management recommendations with prioritization in accordance with at least one embodiment of the present invention.

FIG. 10 is an exemplary process of deactivating an IDER from a VRP in accordance with at least one embodiment of the present invention.

FIG. 11 a schematic diagram illustrating aspects of an example computer in accordance with at least one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, “includes”, “such as”, “for instance”, and “for example” mean “including but not limited to”. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

A system for microgrid interfacing may include a Virtual Resource Platform (VRP) equipped with multiple components to facilitate an integration of a plurality of Integrated Distributed Energy Resources (IDERs). The VRP may include at least one request-handling interface configured to receive one or more requests for interfacing the IDERs with the VRP. The VRP may further include at least one driver identification engine designed to retrieve resource metadata attributes of each IDER to identify corresponding drivers from a drivers database. To enable the interfacing of the IDERs with the VRP, the system may employ at least one standardized Application Programming Interface (API) that utilizes the identified drivers. Additionally, the VRP may include a predictive energy manager connected to the identified drivers of the IDERs, which may fetch telemetry data from the interfaced IDERs and may generate one or more energy management analysis products by analyzing the fetched telemetry data.

A method for microgrid interfacing may receive, through a request-handling interface of a Virtual Resource Platform (VRP), one or more requests for interfacing a plurality of Integrated Distributed Energy Resources (IDERs) with the VRP. The method may further retrieve resource metadata attributes of each IDER using a driver identification engine to identify corresponding drivers from a drivers database, and interfacing of the IDERs with the VRP may be facilitated through a standardized API using the identified drivers. The method may further fetch telemetry data from the interfaced IDERs by a predictive energy manager connected to the identified drivers, and may then generate the one or more energy management analysis products by analyzing the fetched telemetry data.

One or more computer-readable storage media may collectively store computer-executable instructions that, when executed, may cause one or more computers to perform operations for microgrid interfacing. These operations may include receiving one or more requests for interfacing a plurality of Integrated Distributed Energy Resources (IDERs) with a Virtual Resource Platform (VRP) through a request-handling interface and retrieving resource metadata attributes of each IDER using a driver identification engine to identify corresponding drivers from a drivers database. The instructions may enable the interfacing of IDERs with the VRP via a standardized API using the identified drivers. Further, telemetry data may be fetched from the interfaced IDERs by a predictive energy manager connected to the identified drivers, and energy management analysis products may be generated by analyzing the fetched telemetry data.

As will be discussed below in more detail, the predictive energy manager referenced may not only performs predictions, but may also be able to update its predictive characteristics by incorporating new data, for example, from observations, by the importation of external data, or suitable combinations thereof. For example, this may be achieved by importing new data using retrieval augmented generation techniques, and/or by updating reinforcement learning models that interface with a large language model or small language model via language model adapters. This adaptation is sometimes colloquially known as “learning.” In accordance with at least one embodiment, the referenced predictive energy manager adapts from the received telemetry, from imported external data, or suitable combinations thereof.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B, and C together.

The term “a” or “an” entity refers to one or more of that entity. As such, the terms “a” (or “an”), “one or more” and “at least one” can be used interchangeably herein.

The term “automatic” and variations thereof, as used herein, refers to any suitable process or operation done independent of material human input when the process or operation may be performed. However, a process or operation can be automatic, even though performance of the process or operation uses material or immaterial human input, if the input is received before the performance of the process or operation. Human input may be deemed to be material if such input influences how the process or operation will be performed. Human input that consents to the performance of the process or operation may not be deemed to be “material”.

The term “determine” and variations thereof, as used herein, may include any suitable type of methodology, process, operation, and/or technique. Such determinations may include calculations and/or computations.

The term “distributed energy network” and variations thereof, as used herein, may be defined as a collection of a plurality of interconnected energy sources, energy storage facilities, energy consumers and/or consumption points, that may be working individually or collaboratively to produce, store, manage and/or distribute energy across one or more locations.

The term “microgrid” and variations thereof, as used herein, may be defined as a localized, partially or fully self-sufficient energy system that may operate autonomously or in connection with a larger utility grid. A microgrid may encompass various energy generation, storage, and/or consumption components, which may include renewable and non-renewable energy sources, energy storage systems, and diverse end-users or consumers of energy.

The term “Integrated Distributed Energy Resources” (IDERs) and variations thereof, as used herein, may be defined as energy generation, storage, and/or consumption units that are interconnected within a distributed energy network and capable of being integrated into a centralized or decentralized energy management system. IDERs may be characterized by their ability to generate, store, and/or consume energy locally, and their compatibility with communication and control frameworks for real-time monitoring, management, and/or optimization of energy production, storage, and/or consumption within a microgrid or similar energy distribution network.

The term “energy source” and variations thereof, as used herein, may be defined as an entity or mechanism responsible for generating and/or supplying energy within a distributed energy network. A set of energy sources may form a subset of Integrated Distributed Energy Resources (IDERs) and may include renewable energy sources such as solar panels, wind turbines, and hydroelectric plants, as well as non-renewable energy sources such as fossil fuel-based generators and nuclear power plants.

The term “energy consumer” and variations thereof, as used herein, may be defined as a subset of IDERs. The energy consumer may be one or more energy-associated machines. At times, the term energy consumer may be used to refer to a responsible person or entity that utilizes or draws energy from the one or more energy-associated machines. Examples of such energy consumers include an individual, a business, a utility company, or a grid operator. The one or more energy consumers may be associated with one or more energy profiles.

The term “energy storage facilities” and variations thereof, as used herein, may be defined as infrastructure, systems, and/or energy-associated machines and/or devices capable of storing energy for later use. As a subset of Integrated Distributed Energy Resources (IDERs), the energy storage facilities may be integral to distributed energy networks and may function both as energy consumers and energy sources. The energy storage facilities may dynamically shift roles based on energy demands, supply conditions, grid requirements, and/or operational priorities.

The term “user” and variations thereof, as used herein, may be defined as a person or an entity that engages with systems for microgrid interfacing. Such users may perform functions such as viewing, managing, and/or analyzing energy transactions, generating reports, and/or facilitating energy trading. The users may further be enabled to perform functions such as administering, adding, removing, and/or configuring the one or more IDERs. Users may further be enabled to interact with the systems for microgrid interfacing through a user interface, and the interactions may be logged for audit and compliance purposes.

The term “administrator” and variations thereof, as used herein, may be defined as a person or an entity that may have advanced access rights within the systems for microgrid interfacing. The administrator may be responsible for tasks such as configuring system settings, managing user accounts and permissions, enabling data integrity, overseeing compliance with regulatory requirements, and maintaining overall system security. The administrator may have an ability to audit transactions, modify system parameters, and troubleshoot technical issues. The actions performed by the administrator may be logged in the systems for microgrid interfacing for tracking and compliance purposes.

The term “energies” and variations thereof, as used herein, may be defined as various forms of energy, including electrical energy generated from renewable and non-renewable energy sources. The energies may be categorized based on their provenance of generation, such as solar, wind, hydro, fossil fuel, or nuclear, and may be tracked, managed, and traded within the systems for microgrid interfacing.

The term “resource metadata attributes” and variations thereof, as used herein, are defined as descriptive data points or parameters associated with a device and/or resource, providing information about its characteristics, capabilities, and/or operational attributes. The resource metadata attributes may include device types, makes, models, operational capacities, supported protocols, locations, configuration settings, and so forth. Within the context of Integrated Distributed Energy Resources (IDERs), the resource metadata attributes facilitate the identification, classification, and/or interfacing of energy resources with centralized or decentralized energy management systems, enabling efficient communication, control, and/or optimization of resource utilization.

The term “telemetry” and variations thereof, as used herein, may be defined as a process of collecting, transmitting, and/or receiving data from devices or systems for monitoring, analysis, and/or management. Telemetry data may include Key Performance Indicators (KPIs), operational states, energy production metrics, consumption metrics, fault conditions, or other operational insights. In the context of the IDERs, telemetry may serve as an input for real-time energy monitoring, predictive analytics, and/or the generation of energy management recommendations, ensuring optimal operation within microgrids and/or distributed energy environments.

The term “energy allocation” and variations thereof, as used herein, refer to a process of distributing energy resources across a network or system, for example, based on demand, availability, and/or operational priorities. The energy allocation may involve dynamic adjustments to enable efficient resource utilization, grid stability, and/or demand-response management. Within an energy management framework, the energy allocation may be done by considering telemetry data, resource metadata attributes, and/or real-time grid conditions to prioritize and allocate energy to various resources, including generation, storage, and/or consumption units, for seamless integration and optimized performance within microgrid environments.

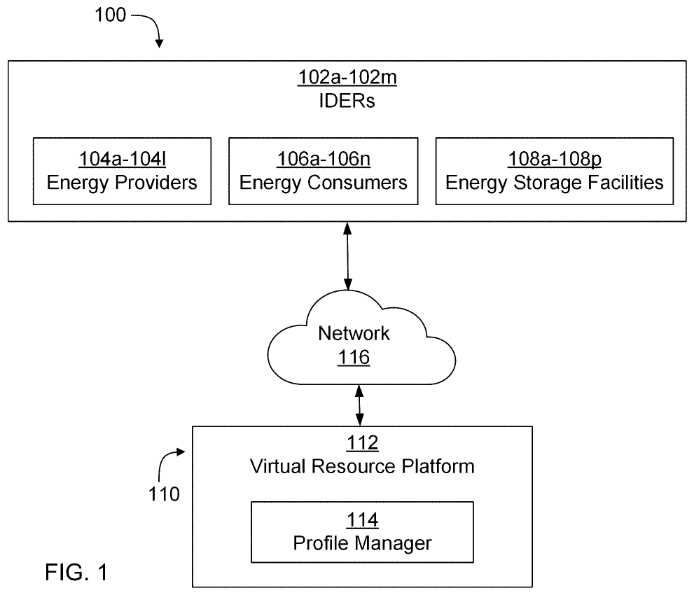

FIG. 1 depicts an exemplary computing environment 100 within distributed energy networks, according to at least one embodiment of the present invention. The computing environment 100 may be configured to enable an integration of a plurality of Integrated Distributed Energy Resources (IDERs) within the distributed energy networks.

In an embodiment of the present invention, the plurality of IDERs 102a-102m (hereinafter also referred to as “IDER 102” or “IDERs 102”) may include various energy generation, energy storage, and/or energy distribution systems. The IDERs 102 may further be associated with one or more of one or more energy providers 104a-1041, one or more energy consumers 106a-106n, and one or more energy storage facilities 108a-108p.

The IDERs 102 may include renewable energy sources such as solar panels, wind turbines, and hydropower stations, non-renewable energy sources such as natural gas plants, coal-based power stations, and nuclear power plants, energy storage systems such as batteries or pumped hydro storage, and Distributed Energy Resources (DERs) such as power grids, microgrids, or localized generators. In certain embodiments of the present invention, the IDERs 102 may also include hybrid energy systems that may combine multiple energy generation technologies. Embodiments of the present invention may be intended to include or otherwise cover any suitable type of IDERs 102, including known, related art, and/or later developed technologies that may be beneficial to contribute to energy generation and management.

The computing environment 100 may include the one or more energy providers 104a-1041 (hereinafter individually referred to as “energy provider 104” or collectively referred to as “energy providers 104”). The one or more energy providers 104 may be, for example, traditional power generation plants such as coal-fired, gas-fired, or nuclear power plants, renewable energy sources such as solar farms, wind farms, hydropower plants, and geothermal energy plants, Distributed Energy Resources (DERs) such as rooftop solar panels and small-scale wind turbines, biomass and waste-to-energy facilities, energy storage facilities such as battery storage plants, fuel cell-based energy generation systems, hydrogen power plants, cogeneration or Combined Heat And Power (CHP) units, microgrid operators providing localized energy production, utility companies acting as intermediaries for power distribution, virtual power plants aggregating energy from multiple small-scale sources, tidal and wave energy plants, synthetic fuel-based power plants, energy cooperatives managing shared renewable energy projects, Electric Vehicle-to-Grid (V2G) systems supplying stored energy from EVs, nuclear fusion pilot plants (as emerging technology), and experimental energy sources, such as kinetic or thermoelectric generators.

The energy providers 104 may also include human-powered energy generation systems, such as pedal-powered generators, hand-crank generators, energy harvested from human movement using wearable devices or pressure-sensitive flooring, and so forth.

The energy providers 104 may be residential users, commercial establishments, industrial facilities, and so forth, in an embodiment of the present invention. The energy providers 104 may also include energy brokers, energy storage systems, and microgrid operators that may produce, store, or redistribute energy, in another embodiment of the present invention. Additionally, the energy providers 104 may include entities that may participate in energy lending, energy borrowing, or trading markets. Embodiments of the present invention may be intended to include or otherwise cover any suitable energy providers 104.

Further, the computing environment 100 may include the one or more energy consumers 106a-106n (hereinafter individually referred to as “energy consumer 106” or collectively referred to as “energy consumers 106”). The energy consumers 106 may include one or more energy-associated machines and/or devices. The one or more energy-associated machines and/or devices may be, for example, heat pumps, Heating, Ventilation, and Air Conditioning (HVAC) systems, electrical appliances such as, refrigerators, washing machines, dishwashers, ovens, and microwaves, generators, electric vehicles, battery storage systems, lighting systems such as LED lights, streetlights, and emergency lighting, air conditioners, water heaters, industrial machinery, such as conveyor belts, pumps, and compressors, automated manufacturing equipment, data centers, computers, mobile phones, smart gadgets, servers, processors, smart home devices, such as, thermostats, smart plugs, and security systems, agricultural equipment, such as irrigation pumps and greenhouse climate control systems, electric forklifts, electric-powered construction tools, electric motors in various applications, medical devices such as oxygen machines, ventilators, diagnostic imaging equipment (e.g., MRI and CT scanners), infusion pumps, patient monitoring systems, and other critical healthcare infrastructure powered by electrical systems and so forth. Embodiments of the present invention may be intended to include or otherwise cover any suitable type of the energy-associated machines and/or devices, including known, related art, and/or later developed technologies.

The energy consumers 106 may also refer to the users of the energy-associated machines and/or devices such as the residential users, the commercial establishments, the industrial facilities, electric vehicle charging stations, healthcare facilities, industries, utility companies, and so forth, in an embodiment of the present invention. The energy consumers 106 may also include the energy brokers, the energy storage systems, and the microgrid operators that may consume, store, or redistribute energy, in another embodiment of the present invention. Additionally, the energy consumers 106 may involve the entities that may participate in energy lending, energy borrowing, or trading markets, as well as those who may seek to optimize their energy usage based on sustainability goals, in yet another embodiment of the present invention. Embodiments of the present invention may be intended to include or otherwise cover any suitable energy consumers 106.

In an embodiment of the present invention, the energy providers 104 and/or the energy consumers 106 may have one or more user devices. The user devices may enable the energy consumers 106 to interact within the computing environment 100. The user devices may be for example smartphones, tablets, laptops, desktop computers, displays, screens, smart watches, smart speakers, smart thermostats, Internet-of-Things (IoT)-enabled devices, and so forth. Embodiments of the present invention may be intended to include or otherwise cover any suitable type of user device 106, including known, related art, and/or later developed technologies.

The user devices may enable the energy providers 104 and the energy consumers 106 to access and interact with a system 110 for microgrid interfacing. Further, the user devices may enable the energy consumers 106 to initiate, stop, monitor, regulate, and optimize energy allocations with a Virtual Resource Platform (VRP) 112. The user devices may further facilitate communication among the energy providers 104, the energy consumers 106 and the computing environment 100 to enable real-time energy management and control. The user devices may include a user interface (not shown) for easy communication and interaction with the system 110 for microgrid interfacing.

In an embodiment of the present invention, the computing environment 100 may include the one or more energy storage facilities 108a-108p (hereinafter individually referred to as “energy storage facility 108” or collectively referred to as “energy storage facilities 108”). The energy storage facilities 108 may be, for example, battery storage systems, pumped hydro storage facilities, flywheels, Compressed Air Energy Storage (CAES), thermal storage units, supercapacitors, gravity-based storage systems, hydrogen-based storage, Liquid Air Energy Storage (LAES), electrochemical storage, thermochemical energy storage, synthetic fuel storage, cryogenic energy storage, and so forth. Embodiments of the present invention may be intended to include or otherwise cover any suitable type of the energy storage facilities 108, including known, related art, and/or later developed technologies.

According to the embodiments of the present invention, the energy storage facilities 108 may be configured to operate dynamically as either the energy sources or the energy consumers 106 based on real-time demand and supply conditions within the computing environment 100. For example, when energy supply exceeds demand, the energy storage facilities 108 may operate as the energy consumers 106 by storing surplus energy. Conversely, during periods of high demand or limited supply, the energy storage facilities 108 may act as energy sources by discharging stored energy back to a grid or to the one or more energy consumers 106. An operational mode and energy flow direction of the energy storage facilities 108 may be controlled by the system 110 for microgrid interfacing, according to some embodiments of the present invention.

In an embodiment of the present invention, the computing environment 100 may include the system 110 for microgrid interfacing. The system 110 for microgrid interfacing may be configured to facilitate seamless integration of Distributed Energy Resources (DERs) within a microgrid network. In an embodiment of the present invention, the system 110 for microgrid interfacing may include the Virtual Resource Platform (VRP) 112. In an embodiment of the present invention, the VRP 112 may include one or more software applications stored in a server (not shown). Alternatively, or in addition, the VRP 112 may be implemented with hardware, firmware, software, or a combination thereof, and may be managed by one or more third-party service providers.

According to an embodiment of the present invention, the VRP 112 may be designed to facilitate integration, management, and optimization of IDERs 102 within the distributed energy networks of the system 110 for microgrid interfacing. In another embodiment of the present invention, the VRP 112 may provide real-time monitoring and control functionalities that may enable users to manage and allocate IDERs 102 efficiently and/or effectively. In a further embodiment of the present invention, the VRP 112 may be deployed on various types of servers, including cloud servers, edge computing servers, remote servers, local servers, third-party servers, or any combination thereof. Embodiments of the present invention may be intended to include or otherwise cover any suitable server architecture, including known, related art, and/or later developed technologies.

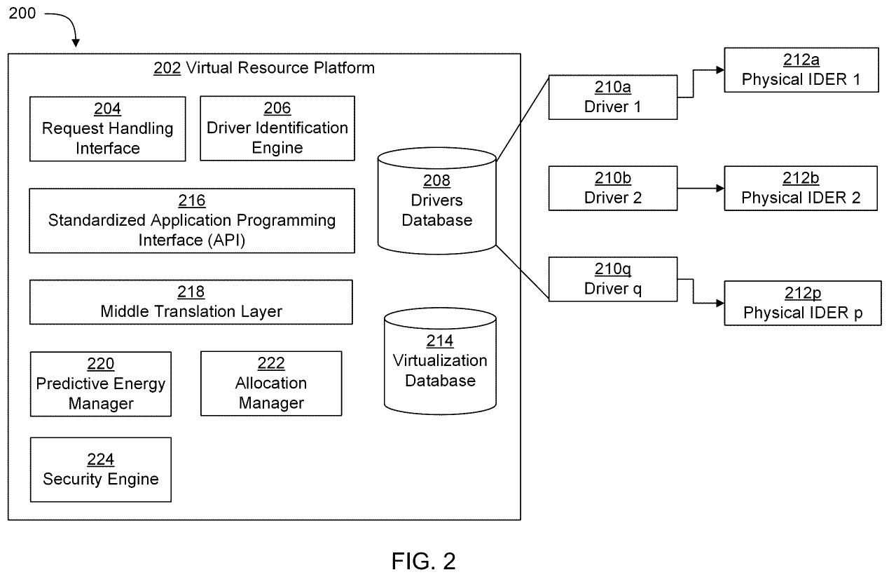

According to the embodiments of the present invention, the VRP 112 may be configured to manage and optimize the interactions among the one or more IDERs 102, the energy consumers 106, and the energy storage facilities 108. The VRP 112 may further be configured to generate predictions, recommendations, reports, or a combination thereof, to improve energy management and allocation. By leveraging advanced analytics and machine-learning-based models, the VRP 112 may be configured to forecast energy demand, generation, and storage capacity, for enabling more efficient operations. The components and functionality of the VRP 112 may be described in further detail in conjunction with FIG. 2.

In an embodiment of the present invention, the system 110 for microgrid interfacing may include a profile manager 114. According to the embodiments of the present invention, the profile manager 114 may be in communication with the VRP 112. The profile manager 114 may be configured to fetch data from the plurality of IDERs of the energy providers 104, energy consumers 106, and the energy storage facilities 108. The profile manager 114 may further be configured to create and maintain profiles for one or more entities within the distributed energy networks of the system 110. According to embodiments of the present invention, the one or more entities such as, the IDERs 102, the energy consumers 106, or the energy storage facilities 108, may have one or more unique profiles. The one or more unique profiles may include operational characteristics, energy generation/consumption patterns, preferred operational settings, and maintenance records corresponding to the entities. The one or more profiles may be dynamically updated based on real-time performance data, energy usage patterns, and environmental factors.

Further, the computing environment 100 may include a network 116. According to the embodiments of the present invention, the network 116 may enable communication and data exchange across various users, participants, and components of the computing environment 100. The network 116 may include a data network such as the Internet, Local Area Network (LAN), Wide Area Network (WAN), Metropolitan Area Network (MAN), etc. In certain embodiments of the present invention, the network 116 may include a wireless network, such as, a cellular network, and may employ various technologies including Enhanced Data Rates For Global Evolution (EDGE), General Packet Radio Service (GPRS), Global System For Mobile Communications (GSM), Internet Protocol Multimedia Subsystem (IMS), Universal Mobile Telecommunications System (UMTS), and so forth. In some embodiments of the present invention, the network 116 may include or otherwise cover networks or sub-networks, one or more of which may include, for example, a wired or wireless data pathway. The network 116 may include a circuit-switched voice network, a packet-switched data network, or any other network capable of carrying electronic communications. For example, the network 116 may include networks based on the Internet Protocol (IP) or Asynchronous Transfer Mode (ATM) and may support voice usage, for example, VoIP, Voice-over-ATM, or other comparable protocols used for voice data communications.

Examples of the network 116 may further include a Personal Area Network (PAN), a Storage Area Network (SAN), a Home Area Network (HAN), a Campus Area Network (CAN), a Local Area Network (LAN), a Wide Area Network (WAN), a Metropolitan Area Network (MAN), a Virtual Private Network (VPN), an Enterprise Private Network (EPN), the Internet, a Global Area Network (GAN), and so forth. Embodiments of the present invention may be intended to include or otherwise cover any type of the network 116, including known, related art, and/or later developed technologies.

FIG. 2 depicts an exemplary functional block diagram of a system 200 for microgrid interfacing in accordance with at least one embodiment of the present invention. The system 200 for microgrid interfacing (FIG. 2) may be an example of the system 110 for microgrid interfacing (FIG. 1). The system 200 for microgrid interfacing may be capable of seamlessly integrating renewable energy sources, energy storage systems, and conventional power grids into a cohesive microgrid network. The system 200 for microgrid interfacing may include a Virtual Resource Platform (VRP) 202. The VRP 202 (FIG. 2) may be an example of the VRP 112 (FIG. 1).

According to the embodiments of the present invention, the VRP 202 may include one or more components such as at least one request-handling interface 204, at least one driver identification engine 206, at least one drivers database 208, one or more drivers 210a-210q (hereinafter referred to as the “drivers 210” or the “driver 210”) corresponding to a plurality of IDERs 212a-212p (hereinafter referred to as the “IDERs 212” or the “IDER 212”), at least one virtualization database 214, at least one Standardized Application Programming Interface (API) 216, at least one Middle Translation Layer 218, at least one Predictive Energy Manager 220, at least one allocation manager 222, and at least one security engine 224. The one or more components of the VRP 202 of the system 200 for microgrid interfacing may be implemented as one or more computer-readable storage media. The one or more computer-readable storage media may collectively include computer-executable instructions that, when executed by one or more processors, enable the functionalities and interactions of the VRP 202 within the system 200. The instructions may enable the VRP 202 to efficiently and/or effectively manage and optimize the interaction between the various components across the system 200.

As described above, it is to be emphasized that the predictive energy manager 220, may not only be predictive, but may make use of artificial intelligence/machine learning and/or generative artificial intelligence techniques to adapt to incoming telemetry, outside data, or suitable combinations thereof.

According to at least one embodiment of the present invention, the request-handling interface 204 may be configured to receive, process, and validate one or more requests associated with the interfacing of the IDERs 212 with the VRP 202. The one or more requests may include one or more requests for registration of the one or more IDERs 212, deregistration of the one or more IDERs 212, telemetry data retrieval from the one or more IDERs 212, status updates of the one or more IDERs 212 and energy resource allocation of the one or more IDERs 212, and so forth. Embodiments of the present invention may be intended to include or otherwise cover any suitable requests that may be handled by the request-handling interface 204, including known, related art, and/or later developed technologies.

The request-handling interface 204 may be configured to employ authentication protocols to enable security and legitimacy of the received requests.

According to at least one embodiment of the present invention, the request-handling interface 204 may further be configured to support multiple communication protocols, such as REST, MQTT, or WebSocket, enabling seamless integration with the IDER 212. Embodiments of the present invention may be intended to include or otherwise cover any suitable protocols for the request-handling interface 204, including known, related art, and/or later developed technologies.

According to at least one embodiment of the present invention, the driver identification engine 206 may be configured to analyze resource metadata attributes of the one or more IDERs 212. The resource metadata attributes may include, such as one or more device types, one or more manufacturers, operational capacity, one or more supported communication protocols, makes and model details, and so forth. Embodiments of the present invention may be intended to include or otherwise cover any suitable resource metadata attributes, including known, related art, and/or later developed technologies.

By analyzing the resource metadata attributes, the driver identification engine 206 may be configured to identify at least one driver 210 from the drivers database 208 required to interface the one or more IDERs 212 with the VRP 202. The identification process may involve matching the retrieved metadata against stored driver specifications. The driver identification engine 206 may further be configured to enable the at least one identified driver 210 to enable communication between the VRP 202 and the one or more IDERs 212 upon interfacing of the one or more IDERs 212 with the VRP 202.

According to at least one embodiment of the present invention, the drivers database 208 may be configured to serve as a repository containing a catalog of the drivers 210 for a wide range of the IDERs 212. The drivers database 208 may include driver-specific details such as versions, supported protocols, compatibility information, configuration parameters, version control data, and so forth. According to at least one embodiment of the present invention, the drivers database 208 may be dynamically updated as new IDER types or versions may be introduced. By maintaining a comprehensive collection of the drivers 210, the drivers database 208 may be configured to enable the VRP 202 to support a diverse ecosystem of the IDERs 212.

In an embodiment of the present invention, the drivers database 208 may be a Relational Database Management System (RDBMS), such as MySQL or PostgreSQL, that may be used to store structured driver-specific details with fixed relationships. In another embodiment of the present invention, the drivers database 208 may be a NoSQL database that may be employed to handle large volumes of unstructured or semi-structured driver-specific details for handling the evolving and diverse nature of the drivers 210 and the IDERs 212. In a further embodiment of the present invention, the drivers database 208 may be a Graph Database (e.g., Neo4j), an Object-Oriented Database, a Distributed Database (e.g., Cassandra), a Cloud-Based Database, such as Amazon RDS or Google Cloud SQL, and so forth. Embodiments of the present invention may be intended to include or otherwise cover any suitable type of the drivers database 208, including known, related art, and/or later developed technologies.

According to at least one embodiment of the present invention, the drivers 210 may act as communication interfaces between the VRP 202 and the IDERs 212. The drivers 210 may be configured to translate commands and data formats between the VRP 202 and a specific type of the IDER 212. For example, the driver 210 may convert high-level API requests into protocol-specific commands compatible with the IDER 212. The drivers 210 may be configured to support bidirectional communication such as the drivers 210 may enable the VRP 202 to transmit instructions to the IDERs 212 and receive telemetry data from the IDERs 212.

In an embodiment of the present invention, the telemetry data fetched from one or more IDERs 212 may include, Key Performance Indicators (KPIs), state triggers of the plurality of IDERs, energy production metrics, energy consumption metrics, and so forth. Embodiments of the present invention may be intended to include or otherwise cover any suitable type of the telemetry data, including known, related art, and/or later developed technologies. The telemetry data may be processed and analyzed by the components of the VRP 202 to facilitate real-time monitoring, optimization, and predictive maintenance of the IDERs 212.

In an embodiment of the present invention, the key performance indicators (KPIs) may be, for example, an operational efficiency, an energy generation capacity, a system uptime, fault occurrence rates, response times to state triggers, a load balancing effectiveness, energy utilization rates, and so forth. The KPIs may include metrics such as peak energy output, minimum energy consumption thresholds, average downtime per unit, maintenance frequency, resource allocation efficiency, and so forth. Embodiments of the present invention may be intended to include or otherwise cover any suitable type of the KPIs, including known, related art, and/or later developed technologies.

In an embodiment of the present invention, the state triggers may be, for example, system status flags, fault conditions, operational thresholds, or activation states. These state triggers may indicate specific events or conditions within the IDERs 212, such as maintenance requirements, overload conditions, or transitions between operational modes.

In an embodiment of the present invention, the energy production metrics may include parameters such as a current energy output, efficiency rates, power generation trends over time, and so forth. Further, the energy consumption metrics may include data points such as demand forecasts, actual consumption rates, peak usage statistics, and so forth. The telemetry data may be aggregated and visualized through a user interface of the VRP 202, according to an embodiment of the present invention. In another embodiment of the present invention, the telemetry data may be exported for integration with external analytics tools.

According to at least one embodiment of the present invention, the standardized API 216 may provide a uniform interface for interacting with the VRP 202. The standardized API 216 may be configured to support functions such as the registration of the IDER 212, energy management commands, telemetry data retrieval, status monitoring, and so forth. Embodiments of the present invention may be intended to include or otherwise cover any suitable functions that may be supported by the standardized API 216, including known, related art, and/or later developed technologies.

By standardizing interactions, the standardized API 216 may be configured to enable a cross-platform compatibility and simplify integration with external energy management systems.

According to at least one embodiment of the present invention, the middle translation layer 218 may act as an intermediary between the standardized API 216 and the drivers 210. The middle translation layer 218 may be configured to translate high-level API requests into driver-specific commands and vice versa. The middle translation layer 218 may further be configured to handle protocol conversion of different communication standards to enable a compatibility between the VRP 202 and IDERs 212. The middle translation layer 218 may further be configured to provide a layer of abstraction by decoupling the standardized API 216 from the underlying drivers 210.

According to at least one embodiment of the present invention, the virtualization database 214 may be configured to store the resource metadata attributes fetched from the one or more IDERs 212, operational details of the one or more interfaced IDERs 212, hierarchical mappings of the one or more interfaced IDERs 212. In an embodiment of the present invention, the hierarchical mappings in the virtualization database 214 may represent relationships and dependencies between the various interfaced IDERs 212. According to the embodiments of the present invention, the virtualization database 214 may organize the relationships and the dependencies between the various interfaced IDERs 212 in a structured, and tiered manner. Thus, the hierarchical mappings may enable efficient management and querying of the interfaced IDERs 212 by reflecting their operational hierarchy and interdependencies.

In an embodiment of the present invention, the virtualization database 214 may further be configured to maintain a record of one or more unique identifiers corresponding to the one or more IDERs 212. The virtualization database 214 may also be configured to store a status of the one or more interfaced IDERs 212, one or more allocation details of the one or more interfaced IDERs 212, and telemetry data of the one or more interfaced IDERs 212. Additionally, the virtualization database 214 may be configured to record historical performance metrics, failure events, configuration settings of the one or more interfaced IDERs 212, and so forth. By serving as a centralized repository, the virtualization database 214 may enable efficient management and analysis of the IDERs 212.

According to at least one embodiment of the present invention, the virtualization database 214 may be implemented as a relational database, a non-relational (NoSQL) database, or a hybrid database system. For example, a relational database may be employed to organize the hierarchical mappings and the metadata for structured queries, while a NoSQL database may be used to store and process unstructured telemetry data or rapidly changing configuration settings. Embodiments of the present invention may be intended to include or otherwise cover any suitable implementation of the virtualization database 214, including known, related art, and/or later developed technologies.

According to at least one embodiment of the present invention, the predictive energy manager 220 may be configured to optimize the performance of the IDERs 212 using machine-learning-based models. The predictive energy manager 220 may be configured to fetch telemetry data from the one or more interfaced IDERs 212 via the one or more identified drivers 210. Once the telemetry data may be fetched, the predictive energy manager 220 may be configured to analyze the fetched telemetry data to detect deviations from expected benchmarks. The predictive energy manager 220 may further be configured to predict potential failures based on the analyzed telemetry data. The predictive energy manager 220 may also be configured to generate one or more energy management analysis products based on the analyzed telemetry data.

The one or more energy management analysis products may be, for example, energy management recommendations, energy management predictions, energy management graphs, load optimization strategies, energy efficiency scores, resource allocation plans, power demand forecasts, energy cost-saving models, maintenance scheduling recommendations, energy utilization heatmaps, real-time energy flow visualizations, outage probability predictions, carbon footprint analysis, renewable energy contribution reports, storage capacity utilization graphs, operational efficiency reports, peak load management strategies, dynamic pricing recommendations, system reliability metrics, energy trade optimization insights, virtual IDER performance reports, energy impact assessments, and so forth. Embodiments of the present invention may be intended to include or otherwise cover any suitable energy management analysis products, including known, related art, and/or later developed technologies.

In an embodiment of the present invention, the predictive energy manager 220 may be configured to prioritize the generated energy management recommendations dynamically based on real-time fetched telemetry data and historical telemetry data. In an embodiment of the present invention, the predictive energy manager 220 may be configured to set one or more thresholds for one or more parameters of the fetched telemetry data, such as, a minimum threshold, an average threshold, and a maximum threshold for the fetched telemetry data from one or more of the IDERs 212. The minimum threshold may be defined as a minimum expected value(s) for one or more parameters of the fetch telemetry data. The maximum threshold may be defined as the maximum expected value(s) for one or more parameters of the fetched telemetry data. The average threshold may represent a benchmark value based on historical data trends for the same parameters, and may further serve as a reference point for typical behavior of the one or more of the IDERs 212. By setting and/or adjusting the one or more thresholds for the one or more parameters of the fetch telemetry data, the predictive energy manager 220 may be configured to handle variations in resolutions of the telemetry data fetched the one or more IDERs 212.

According to the embodiments of the present invention, the predictive energy manager 220 may be configured to generate one or more error notifications when the fetched telemetry data of the one or more IDERs 212 fails to meet the set minimum threshold. In an embodiment of the present invention, the one or more error notifications may be generated based on analysis of the fetched telemetry data using the machine-learning-based models. The machine-learning-based models may be, for example, anomaly detection models, classification models, neural networks, clustering models, reinforced learning models, ensemble learning models, time-series forecasting models, deep reinforcement learning models, self-supervised learning models, federated learning models, dimensionality reduction techniques, and so forth. Embodiments of the present invention may be intended to include or otherwise cover any suitable machine-learning-based models, including known, related art, and/or later developed technologies.

The predictive energy manager 220 may further be configured to detect anomalies and predict issues, such as underperformance or failure risks.

The working and functions of the predictive energy manager 220, achieved by setting the minimum threshold, may further be understood by the following exemplary embodiment.

In an exemplary embodiment of the present invention, the predictive energy manager 220 may fetch the telemetry data from one or more IDERs 212, such as energy storage systems, photovoltaic units, or wind turbines, operating within a specific microgrid. The telemetry data of the one or more IDERs 212 may include the one or more parameters such as energy output, temperature, voltage, and operational status. The predictive energy manager 220 may be configured to analyze the fetched telemetry data to identify the minimum threshold for performance thresholds, such as a minimum voltage level required for stable grid operation. For instance, if the voltage from the one or more IDERs 212 should remain above a specific threshold for the grid stability, the minimum threshold may be set to a lowest value permissible across some or all of the one or more IDERs 212.

If the telemetry data from any of the one or more IDERs 212 indicates a failure to meet the minimum threshold such as a photovoltaic unit reporting a voltage below a set voltage threshold, the predictive energy manager 220 may be configured to generate the one or more error notifications. The one or more error notifications may include, for example, details of the one or more IDERs 212 at fault, a specific telemetry parameter failing the minimum threshold, a potential impact on the microgrid's operation, and so forth. The one or more error notifications may be transmitted to operators or other system components for immediate corrective action.

In an embodiment of the present invention, the predictive energy manager 220 may be configured to prioritize the one or more energy management recommendations based on a weighted analysis of both real-time and historical data. The one or more prioritized energy management recommendations may enable the most critical actions to be taken first. In an embodiment of the present invention, the predictive energy manager 220 may be configured to continuously monitor the fetched telemetry data of the IDERs 212. Based on the continuous monitoring of the fetched telemetry data, the predictive energy manager 220 may be configured to adjust the one or more prioritized energy management recommendations grounded on changing conditions. The operation and functionality of the predictive energy manager 220 in relation to the prioritization of the one or more energy management recommendations may further be understood through the following exemplary embodiment.

In an exemplary embodiment of the present invention, the predictive energy manager 220 may be configured to continuously monitor the telemetry data fetched from the one or more IDERs 212 within the system 200. For instance, real-time data from a wind turbine identified as the IDER 212a may indicate a significant drop in energy production due to low wind speeds. Simultaneously, the telemetry data fetched from a battery storage unit identified as the IDER 212b may reveal a rapid decline in charge levels caused by increased energy demand. In such a scenario, the predictive energy manager 220 may be configured to analyze the telemetry data fetched in real-time alongside historical telemetry data stored in the virtualization database 214. The historical telemetry data may show that the wind turbine IDER 212a frequently experiences reduced output during specific weather conditions and that the battery storage unit IDER 212b may often deplete quickly when compensating for other underperforming IDERs 212. Based on this weighted analysis, the predictive energy manager 220 may be configured to prioritize the one or more energy management recommendations to maintain the grid stability. The one or more prioritized energy management recommendations may include increasing a reliance on a photovoltaic unit such as IDER 212c during peak sunlight hours while scheduling maintenance for the wind turbine IDER 212a and redistributing the load to reduce strain on the battery storage unit IDER 212b.

As conditions evolve, the predictive energy manager 220 may be configured to dynamically adjust the priority of the one or more prioritized energy management recommendations. For instance, in case the fetched telemetry data shows that a charge level of the IDER 212b may be stabilizing due to reduced grid demand or operational improvements, its priority for an immediate action may be lowered. Conversely, in case the energy production from the wind turbine IDER 212a continues to decrease, the predictive energy manager 220 may be configured to elevate its priority, recommending urgent maintenance or load redistribution. This continuous monitoring and dynamic adjustment process may enable that the most critical actions may be taken first, adapting to real-time changes to maintain optimal performance of the system 200 for microgrid interfacing.

These examples of the predictive energy manager 220 may be provided for illustrative purposes and are not intended to limit the scope of the present invention. Embodiments of the present invention may include any suitable modifications and enhancements to the functionality of the predictive energy manager 220, in accordance with principles and objectives described herein.

According to at least one embodiment of the present invention, the allocation manager 222 may be configured to handle the allocation and deallocation of one or more energy resources with the IDERs 212. The allocation manager 222 may be configured to enable that the energy resources may be allocated efficiently based on predefined priorities, demand patterns, and system constraints. The allocation manager 222 may also be configured to monitor resource usage and adjust allocations dynamically to accommodate changes in demand or operational conditions.

In an exemplary embodiment of the present invention, the allocation manager 222 may be configured to dynamically manage the allocation of the one or more energy resources among the IDER 212a, the IDER 212b, and the IDER 212p based on changing operational conditions. For instance, consider a scenario where the IDER 212a, a solar photovoltaic system, may be generating excess energy during peak sunlight hours. The allocation manager 222 may allocate the surplus energy from the IDER 212a to the IDER 212p, an energy storage system, enabling that the excess energy may be stored for later use during periods of low solar output.

Simultaneously, if the fetched telemetry data indicates that the IDER 212b, a wind turbine, may be experiencing a reduced generation due to low wind speeds, the allocation manager 222 may reallocate energy from the IDER 212p to compensate for the shortfall. Thus, the allocation manager 222 may be configured to enable a continuous energy supply to priority entities, such as hospitals or manufacturing units, without disrupting their operations. Moreover, the allocation manager 222 may be configured to monitor demand patterns and prioritize energy distribution accordingly. For example, during evening hours when residential demand increases, the allocation manager 222 may be configured to allocate stored energy from the IDER 212p to meet a surge in consumption while reducing the energy supplied by the IDER 212a to preserve its capacity for the next day.

According to at least one embodiment of the present invention, the security engine 224 may be configured to enable secure API interactions between the interfaced IDERs 212 and the VRP 202. The security engine 224 may be configured to employ encryption, authentication, and access control mechanisms to safeguard sensitive data and prevent unauthorized access. Additionally, the security engine 224 may be configured to continuously monitor the system 200 for potential security threats and vulnerabilities, and may be configured to initiate corrective actions to protect the system 200 from cyberattacks, data breaches, or other security risks.

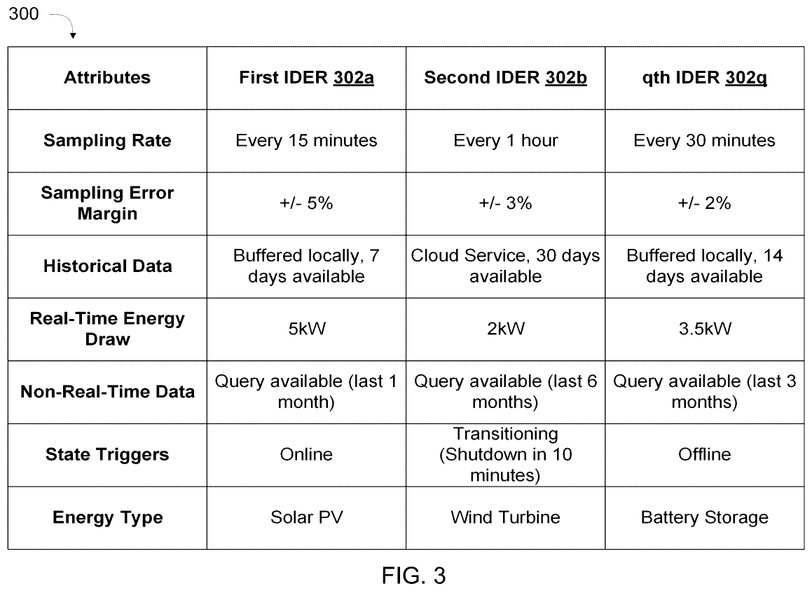

FIG. 3 may be an exemplary Table 300 of resource metadata attributes of the IDERs 302a-302q in accordance with at least one embodiment of the present invention. The IDERs 302a-302q (FIG. 3) may be an example of one or more of the IDERs 102 (FIG. 1) or the IDERs 212 (FIG. 2).

In an exemplary scenario of the present invention, there may be q numbers of the IDERs 302a-302q, such as a first IDER 302a, a second IDER 302b, and a qth IDER 302q. The one or more IDERs 302a-302q may correspond to a distinct energy generation or energy storage system characterized by unique resource metadata attributes. The resource metadata attributes of the IDERs 302a-302q may enable the VRP 202 to manage, monitor, and integrate distributed energy resources within an energy management framework, such as a smart grid. The resource metadata attributes may be one or more of a sampling rate, a sampling error margin, historical data availability, real-time energy draw, non-real-time data queryability, operational states, energy type, and so forth. Embodiments of the present invention may be intended to include or otherwise cover any suitable resource metadata attributes, including known, related art, and/or later developed technologies.

For instance, the sampling rate may define the frequency of data collection, wherein the first IDER 302a may sample data every 15 minutes to provide high granularity, the second IDER 302b may sample data every hour, achieving a balance between resource efficiency and detail, and the qth IDER 302q may sample data every 30 minutes, offering moderate resolution suited for storage-related applications. Further, the sampling error margin may indicate the precision of the data, with the first IDER 302a having an error margin of ±5%, which may be acceptable for relatively stable solar PV outputs, the second IDER 302b having an error margin of ±3%, suitable for the variable nature of wind turbine outputs, and the qth IDER 302q having an error margin of ±2%, thereby providing enhanced precision for battery storage functionality.

Further, the historical data availability may vary across the IDERs 302a-302q. For example, the first IDER 302a may buffer data locally for a period of seven days, the second IDER 302b may utilize cloud-based storage to maintain data for thirty days, and the qth IDER 302q may combine local buffering for fourteen days with rapid retrieval capabilities. In an exemplary scenario of the present invention, the real-time energy draw may correspond to the operational output of the energy resources, wherein the first IDER 302a may produce 5 Kilowatts (kW) of energy from solar PV, the second IDER 302b may generate 2 kW from wind turbines, and the qth IDER 302q may supply 3.5 kW via battery storage to meet demand peaks. The non-real-time data may be queried over specific time frames, such as one month for the first IDER 302a, six months for the second IDER 302b, and three months for the qth IDER 302q, thereby enabling comprehensive historical analysis.

Further, the operational states may be defined by the state triggers, such as the first IDER 302a may operate in an online mode, the second IDER 302b may transition to a shutdown mode within 10 minutes, and the qth IDER 302q may remain offline, potentially for maintenance purposes. Further, the energy type associated with the one or more IDERs 302a-302q may include solar PV for the first IDER 302a, wind turbine generation for the second IDER 302b, and battery storage for the qth IDER 302q.

Thus, the resource metadata attributes of the IDERs 302a-302q, as described, may provide a comprehensive framework for the VRP 202 to effectively manage, monitor, and integrate the IDERs 302a-302q within the distributed energy networks.

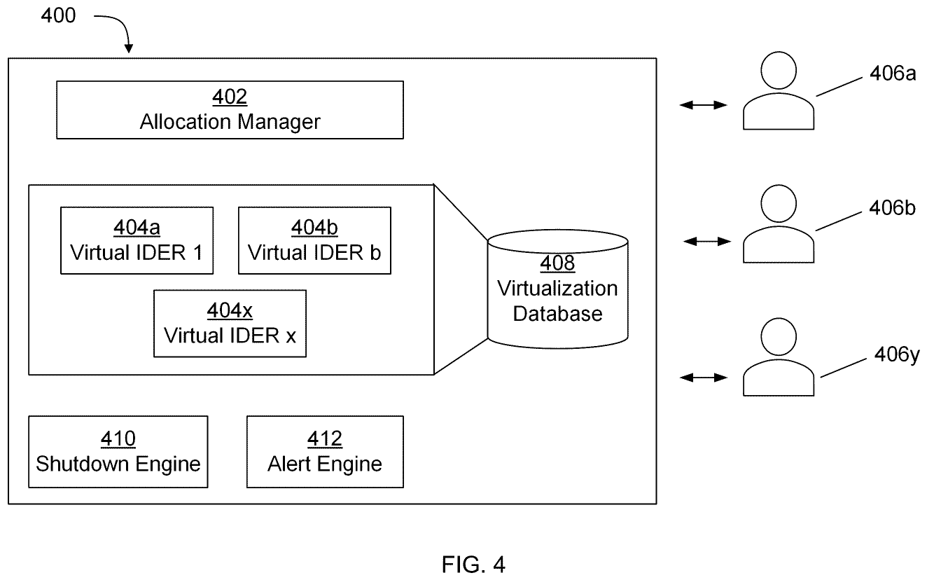

FIG. 4 may be an exemplary functional diagram of a Virtual Resource Platform (VRP) 400 in accordance with at least one embodiment of the present invention. The VRP 400 (FIG. 4) may be an example of one or more of the VRP 112 (FIG. 1), or the VRP 202 (FIG. 2). The VRP 400 may include an allocation manager 402 that may be an example of the allocation manager 222 (FIG. 2).

According to an embodiment of the present invention, the allocation manager 402 may be configured to dynamically allocate the one or more virtual IDERs 404a-404x to the one or more energy consumers 406a-406y based on predefined allocation rules.

In an embodiment of the present invention, the VRP 400 may enable the virtualization of one or more physical IDERs (e.g., Physical IDERs 212, as explained in the FIG. 2) into the one or more virtual IDERs 404a-404x upon interfacing of the one or more physical IDERs 212 with the VRP 400. The one or more virtual IDERs 404a-404x may imitate operations and processing of the one or more physical IDERs, according to at least one embodiment of the present invention. Further, the one or more energy consumers 406a-406y may be interfaced with the VRP 400 to receive energies based on the allocated energy resources. The one or more energy consumers 406a-406y may be an example of the energy consumers 106 as explained in the FIG. 1.

In an embodiment of the present invention, the VRP 400 may include a shutdown engine 410 that may be configured to enable a controlled deactivation of the one or more virtual IDERs 404a-404x. The shutdown engine 410 may be configured to prevent failures of the distributed energy networks of the virtual IDERs 404a-404x. The shutdown engine 410 may be configured to initiate orderly shutdown processes under specific conditions to enable system stability and prevent overloading.

In an embodiment of the present invention, the VRP 400 may further include an alert engine 412. The alert engine 412 may be configured to detect anomalies, operational deviations, or vulnerabilities within the system 200 (as explained in the FIG. 2). The alert engine 412 may further be configured to generate real-time alerts with detailed information on potential issues, such as underperformance or failure risks to enable prompt corrective actions. The alert engine 412 may be configured to provide notifications to operators or other components of the VRP 400 to facilitate efficient issue resolution.

The functionalities of the shutdown engine 410 and the alert engine 412 may further be understood by the following examples.

For instance, consider a scenario where the VRP 400 may be interfaced with multiple physical IDERs and their corresponding virtual IDERs 404a-404x, as well as a set of energy consumers 406a-406y. The shutdown engine 410 may receive input telemetry data from the physical IDERs and the virtualization database 408. The telemetry data may include metrics such as current load, temperature, voltage levels, operational cycles, and error reports. For example, if a physical IDER exceeds a predefined temperature threshold, the shutdown engine 410 may flag it as a potential risk for overloading or failure. Upon detecting the risk, the shutdown engine 410 may analyze the severity of the issue using predefined algorithms or thresholds stored in the virtualization database 408. If the analysis indicates imminent failure, the shutdown engine 410 may decide to deactivate the affected physical IDER and its corresponding virtual IDER 404a. The shutdown engine 410 may communicate this decision to the allocation manager 402. This communication may include detailed information such as the IDER ID, the reason for the shutdown, and the amount of energy resources affected. The allocation manager 402 may retrieve resource allocation data from the virtualization database 408 and may identify the one or more virtual IDERs 404b-404x alternative to the virtual IDER 404a to compensate for the loss of the affected virtual IDER 404a. For instance, if the IDER 404a may be supplying 50 kW of energy to the energy consumer 406a, the allocation manager 402 may redistribute the load among the IDERs 404b and 404c, such that the IDERs 404b and 404c may supply 25 kW each to the energy consumer 406a. The allocation manager 402 may update the virtualization database 408 to reflect the new allocation plan. The allocation manager 402 may also mark the deactivated IDER 404a as unavailable for future allocations. For example, a database entry for the IDER 404a may be modified to include a status field marked as “Inactive” with an associated timestamp.

Simultaneously, the alert engine 412 may be configured to generate a real-time notification detailing the shutdown event. The alert may include the IDER ID, a reason for the shutdown, affected consumers, for example, the energy consumer 406a, and reallocation details. The alert engine 412 may transmit the notification to system operators via email, dashboard updates, or mobile applications for review and further action. Once the reallocation may be confirmed, the shutdown engine 410 may initiate the controlled deactivation of the affected physical IDER and its virtual IDER 404a. This process may include safely disconnecting the physical IDER from the grid and enabling no residual energy transfer to prevent potential damage.

In another exemplary scenario of the present invention, the VRP 400 may handle one or more shutdown requests initiated by an IDER operator and classify them into soft shutdowns or hard shutdowns. The VRP 400 may handle shutdown requests initiated by an operator of a physical IDER and classify them into soft shutdowns or hard shutdowns based on operational conditions, one or more priority calls of one or more allocations, and a criticality of the one or more shutdown requests. In accordance with at least one embodiment, a priority call may be an indication or signal having special priority over other indications or signals. There may be several levels of priority such that higher priority calls have priority over lower priority calls. The standardized API (e.g., standardized API 216, as explained in the FIG. 2) may receive the one or more shutdown requests from the operator, including details such as the IDER ID, the reason for the shutdown, for example, “scheduled maintenance” or “hardware malfunction”, an urgency level for example, “normal” or “critical”, and so forth.

The shutdown engine 410 may be configured to detect the one or more priority calls associated with a shutdown request to determine its criticality and urgency. This detection may involve analyzing metadata embedded in the shutdown request, such as an assigned priority level, timestamp, or specific keywords indicating critical scenarios (e.g., “emergency shutdown” or “immediate hazard mitigation”). Based on the detected priority, the shutdown engine 410 may be configured to dynamically adjust a classification criteria to expedite the handling of high-priority requests. For instance, in scenarios where the priority call indicates a “critical” status, the shutdown engine 410 may be configured to bypass certain checks, such as waiting for the threshold time duration, and directly classify the request as a hard shutdown. In such cases, the shutdown engine 410 may also be configured to trigger immediate notifications to relevant entities, including the operators of the one or more energy consumers 406a-406y, one or more grid controllers, and maintenance personnels, and so forth.

The shutdown engine 410 may be configured to analyze the received shutdown request against predefined criteria stored in the virtualization database 408 to classify a type of shutdown. According to an embodiment of the present invention, the predefined criteria may include a threshold time duration. For instance, if the time associated with the shutdown request may be less than the threshold time duration, the shutdown may be classified as a hard shutdown, which may involve an immediate termination of the IDERs' operations without guaranteeing a completion of ongoing tasks or processes. Conversely, if the time associated with the shutdown request exceeds the threshold time duration, the shutdown may be classified as the soft shutdown. In this scenario, the shutdown engine 410 may enable that all critical tasks may be completed and the energy consumers 406a-406y may be notified and provided with a safe duration before deactivating the virtual IDERs 404a-404x.

The shutdown engine 410 may also be configured to transmit command signals regarding the classified shutdown to the allocation manager 402. If the request may be classified as the soft shutdown, the shutdown engine 410 may notify the allocation manager 402 to reallocate the energy resources associated with the affected physical IDER to one or more other virtual IDERs 404b-404x before deactivating the physical IDER and its corresponding virtual IDER 404a. The allocation manager 402 may dynamically redistribute the energy resources to enable uninterrupted service to the energy consumers 406a-406y. If the request may be classified as a hard shutdown, the shutdown engine 410 may initiate an immediate deactivation of the physical IDER and its counterpart, the virtual IDER 404a to prevent potential system damage or cascading failures.

Concurrently, the alert engine 412 may be configured to generate real-time notifications to operators and system components regarding the critical status, while the allocation manager 402 may be configured to expedite the reallocation of energy resources to unaffected physical IDERs to mitigate service disruptions. The virtualization database 408 may be updated to reflect the shutdown status, including the reason and timestamp, and the alert engine 412 may notify relevant entities, including the energy consumers 406a-406y, about the adjustments made to maintain system reliability.

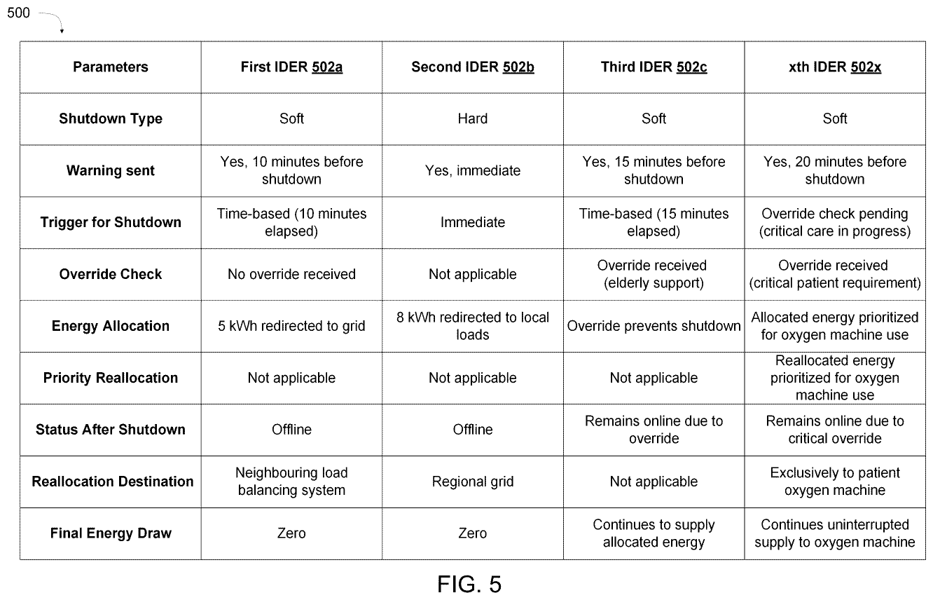

FIG. 5 may be an exemplary Table 500 of system parameters associated with IDERs 502a-502x in accordance with at least one embodiment of the present invention. The IDERs 502a-502x (FIG. 5) may be an example of the at least one of the IDERs 102 (FIG. 1), the IDERs 212 (FIG. 2), or IDERs 302a-302q (FIG. 3).

In an exemplary scenario of the present invention, the one or more of the IDERs 502a-502x, for example, a first IDER 502a, a second IDER 502b, a third IDER 502c, and a xth IDER 502x may be interfaced to a VRP (for example the VRP 202 as explained in the FIG. 2). The VRP may be configured to evaluate the status of the one or more IDERs 502a-502x based on system parameters. The system parameters may include, such as shutdown types (soft or hard), warning notifications, shutdown triggers, override checks, energy allocation strategies, priority reallocations, IDER status after shutdown, and so forth.

These system parameters may allow the VRP to coordinate actions that optimize system resilience and resource utilization.

For instance, the first IDER 502a may undergo a soft shutdown triggered by a time-based condition. The system parameters indicate that a warning was sent 10 minutes before the shutdown, allowing the VRP to prepare downstream systems for the transition. The VRP may be configured to evaluate an absence of override checks to determine that no critical conditions or dependencies exist to prevent the shutdown. The allocation manager of the VRP may redirect 5 kWh of energy from IDER 502a to a neighboring load-balancing system. This energy redirection may enable that local energy demands may remain unaffected. After reallocation, the VRP transitions IDER 502a into an offline state with zero final energy draw. In this case, the VRP may be configured to take an informed decision by considering the time-based trigger, verifying the lack of override conditions, and leveraging the allocation manager to minimize the impact of the shutdown. The predictive energy manager may further enable that energy redirection may be executed to meet nearby demands effectively.

As depicted in the Table 500, the second IDER 502b may request for a hard shutdown triggered immediately by an urgent condition. In such scenario, the VRP may be configured to coordinate the shutdown process by issuing a warning at the time of shutdown to inform associated energy resources of the event. The VRP may bypass a need for an override check, as the urgency of the shutdown overrides the usual validation processes. At such instances, the allocation manager of the VRP may redirect 8 kWh of energy to local loads to maintain stability in the affected region. After enabling the safe redirection of energy, the VRP may transition the IDER 502b into an offline state, with no residual energy remaining.

Further, as depicted in the Table 500, the third IDER 502c may request for a soft shutdown that may be triggered by a time-based condition set at 15 minutes. However, during the shutdown process, the VRP may identify an override condition through its override check. In an exemplary scenario of the present invention, the override condition may arise from a critical dependency related to elderly support. In such a scenario, the VRP may be configured to evaluate a dependency of the third IDER 502c and may instruct the allocation manager to prevent the shutdown to enable that IDER 502c to continue its operations. The energy from the IDER 502c may be maintained at its current allocation to support the dependent energy resources.

As depicted in the Table 500, the xth IDER 502x may request for a soft shutdown with an initial event trigger of a 20-minute warning notification. In such a scenario, during the override check, the VRP may detect a critical dependency involving a patient's oxygen machine. The predictive energy manager may analyze the situation and may identify that the energy allocation from the IDER 502x may be critical for the patient's survival. Consequently, the VRP may instruct the allocation manager to dynamically reallocate energy from other non-essential IDERs in the network to maintain the operational status of the IDER 502x. The final status of the IDER 502x may remain online, with its energy exclusively allocated to the critical care system.

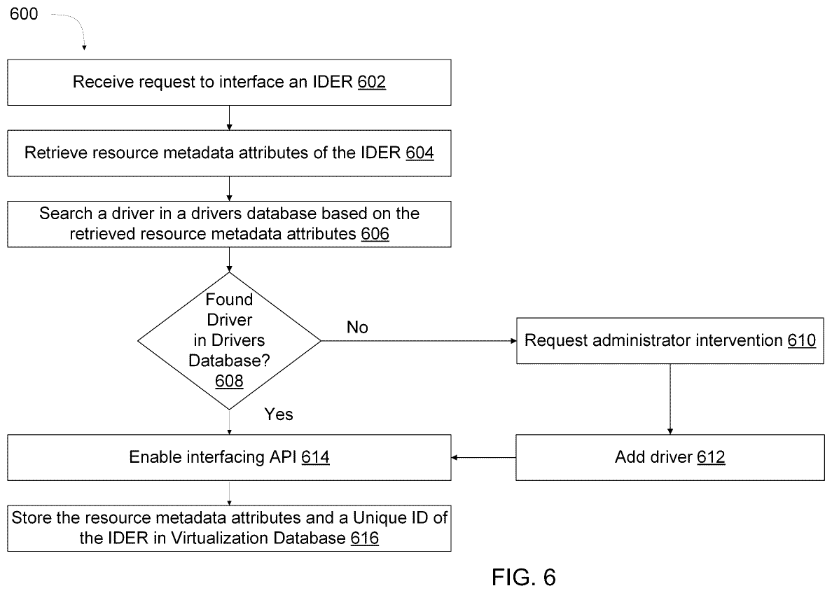

FIGS. 6-10 may present illustrative one or more processes 600-1000 for implementing systems for microgrid interfacings, in accordance with at least one embodiment of the present invention. It is to be understood that the processes 600-1000, as illustrated in the FIGS. 6-10, may be described in accordance with at least one embodiment of the present invention without direct reference to specific numerals of the components depicted corresponding to the systems 110 (FIG. 1) or 200 (FIG. 2) for microgrid interfacing. The omission of specific numerals for components in describing the processes 600-1000 may not limit the scope of the invention, and the processes 600-1000 may be implemented using any suitable configuration or arrangement of the components described in the systems 110 (FIG. 1) or 200 (FIG. 2) for microgrid interfacing.

The one or more processes 600-1000 may be illustrated as a collection of blocks in a logical flowchart, which represents a sequence of operations that may be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations may be described may not be intended to be construed as a limitation, and any number of the described blocks may be combined in any suitable order and/or in parallel to implement the process.

FIG. 6 may be an exemplary process 600 of interfacing an Intelligent Distributed Energy Resource (IDER) with the Virtual Resource Platform (VRP), in accordance with at least one embodiment of the present invention. The process 600 may demonstrate how the VRP handles requests for interfacing an IDER by ensuring compatibility through driver management and storing metadata for operational use.

At 602 block, the VRP may receive a request to interface an IDER. This request may originate from an authorized user or an automated system and may include various details about the IDER, such as operational parameters, communication protocol, and an energy type. The request may trigger the subsequent steps for verifying and enabling the IDER to communicate with the VRP.

At 604 block, the VRP may retrieve resource metadata attributes of the IDER. The attributes may include data such as the IDER's manufacturer, version, functional capabilities, supported APIs, and communication protocol details. This metadata retrieval step may help determine whether a suitable driver exists in the system 200. The metadata may be stored temporarily or flagged for further processing, depending on the interfacing requirements. The retrieved attributes may form the basis for the compatibility check performed in the subsequent blocks.

At 606 block, the VRP may search for a driver in a drivers database based on the resource metadata attributes retrieved. This search may involve querying a repository of drivers to locate one that matches the IDER's specifications. If multiple drivers may be available, the VRP may select the most compatible or updated version to enable optimal functionality.

At 608 block, the VRP may determine whether a compatible driver may be found in the drivers database or not. If the compatible driver is identified, the process 600 may proceed to a block 614. In case, if a compatible driver is not found, the VRP may initiate alternative steps, such as requesting intervention from an administrator at a 610 block.

At the 610 block, the VRP may request an admin intervention if a compatible driver is not found. This request may be transmitted as a notification to an admin dashboard, including details of the missing driver and the specific resource metadata attributes of the IDER.

At 612 block, the VRP may enable the admin to add a driver. This addition may involve uploading a driver software to the VRP, registering it in the database, and validating its compatibility with the IDER. Once the driver is added, the process 600 may proceed to the 614 block.

At the 614 block, the VRP may enable interfacing of the IDER via a standardized API. This step may establish a communication link between the IDER and the VRP and may allow them to exchange data and commands. The interfacing process may include further processes, such as authenticating the IDER, synchronizing its operational parameters, and initializing communication. The standardized API may also monitor the interfacing process to enable a stable connection and resolve any errors that occur during initialization.

Further, at 616 block, the VRP may store the resource metadata attributes and the unique ID of the interfaced IDER in the Virtualization Database. This storage may facilitate future interactions with the IDER such as to allow the VRP to retrieve its details without requiring another metadata retrieval process.

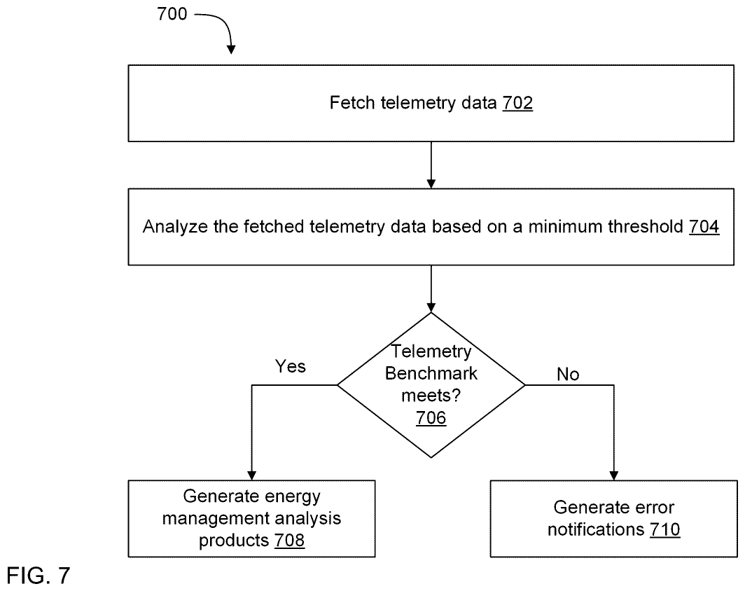

FIG. 7 may be an exemplary process 700 of managing the telemetry data of the IDER in accordance with at least one embodiment of the present invention. The process 700 may outline how the VRP systematically fetches, analyzes, and evaluates telemetry data to generate actionable outcomes for energy management or error notifications.

At 702 block, the VRP may fetch telemetry data from the IDER. The fetched telemetry data may include parameters such as power output, energy consumption, voltage, temperature, and other operational metrics recorded at specified intervals. The telemetry data may be collected through secure communication channels using standard protocols such as MQTT, HTTP, or others depending on the configuration of the IDER. The fetched telemetry data may be temporarily stored in a cache or directly transferred for further processing, enabling a minimal latency in data management.

At 704 block, the VRP may analyze the fetched telemetry data based on the minimum threshold. The analysis of the fetched telemetry data may involve normalizing the data across different IDERs to enable compatibility and comparability. The VRP may use advanced algorithms, including machine-learning-based models, to detect patterns, outliers, and anomalies within the fetched telemetry data. The minimum threshold analysis may account for variations in IDER configurations. According to the embodiment of the present invention, the minimum threshold analysis may enable the performances of the IDERs to remain consistent across the different entities.

At 706 block, the VRP may determine whether the analyzed telemetry data meets one or more predefined benchmarks or not based on the set minimum threshold. The one or more predefined benchmarks may be established based on historical data, manufacturer recommendations, regulatory standards, or third-party benchmarks. The VRP may compare the analyzed telemetry data against the one or more predefined benchmarks to evaluate performance and identify potential deviations. If the analyzed telemetry data meets the one or more predefined benchmarks, the process 700 may proceed to a 708 block. Otherwise, the process 700 may proceed to a 710 block.

At the 708 block, the VRP may generate one or more energy management analysis products upon meeting the one or more predefined benchmarks by the analyzed telemetry data of the one or more IDERs. The one or more energy management analysis products may include the energy management recommendations or suggestions for improving efficiency, such as optimizing load distribution, adjusting operational schedules, integrating renewable energy sources, and so forth. The one or more energy management recommendations may further include insights, such as reducing operational costs, enhancing a lifespan of the IDERs, or minimizing an environmental impact. The one or more energy management recommendations may be presented via a dashboard or may be communicated directly to the IDER for autonomous implementation, according to an embodiment of the present invention.

Further, at 710 block, the VRP may generate one or more error notifications upon the analyzed telemetry data of the one or more IDERs that fail to meet the one or more predefined benchmarks. The one or more error notifications may include detailed diagnostic reports highlighting a part of the analyzed telemetry parameters that deviate from the one or more predefined benchmarks. The one or more generated error notifications may be transmitted to administrators, service personnels, or system logs for further investigation. The one or more generated error notifications may also recommend corrective actions, such as performing maintenance, replacing components, or updating firmware, to resolve the identified issues, according to an embodiment of the present invention.

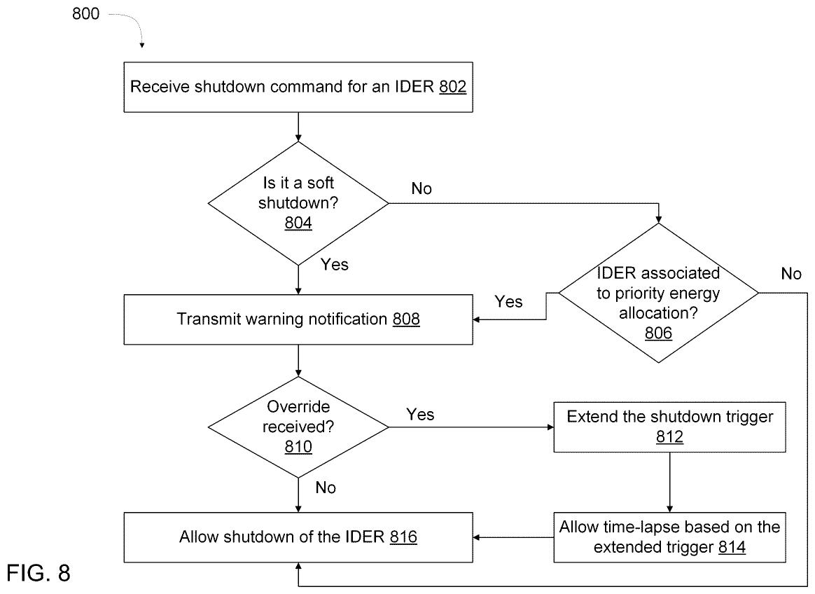

FIG. 8 may be an exemplary process 800 of handling the shutdown of the IDER in accordance with at least one embodiment of the present invention. The process 800 may outline a systematic approach to enable the shutdown of the IDER to be performed in a controlled, reliable, and safe manner.

At 802 block, the process 800 may receive a shutdown command for an IDER. The VRP may validate the shutdown command. In an embodiment of the present invention, the received shutdown command may be validated by transmitting a verification request to an authentication server. In another embodiment of the present invention, the received shutdown command may be validated by checking an encryption key associated with the received shutdown command. Embodiments of the present invention may be intended to include or otherwise cover any suitable method for the validation of the received shutdown command, including known, related art, and/or later developed technologies. By validating the received shutdown command, the VRP may be configured to safeguard against unintended disruptions to energy operations.

At 804 block, the VRP may evaluate the type of shutdown specified in the received shutdown command, determining whether it indicates the hard shutdown or the soft shutdown. The soft shutdown may allow for preparatory measures to mitigate disruption, while the hard shutdown may entail an immediate cessation of the energy operations. If the shutdown command specifies the hard shutdown, the process 800 may proceed to a 806 block. Conversely, if the shutdown command specifies a soft shutdown, the process 800 may proceed to a 808 block.

At the 806 block, the VRP may check whether the IDER scheduled for the shutdown may be associated with one or more priority energy allocations. According to embodiment of the present invention, the VRP may be configured to categories the energy allocations based on one or more predefined priority criteria. The one or more predefined priority criteria may be, for example, critical operations, essential energy loads, emergency services, grid stability functions, and so forth. Embodiments of the present invention may be intended to include or otherwise cover any suitable criteria for the one or more priority energy allocations, including known, related art, and/or later developed technologies. If the one or more priority energy allocations exist that may be associated to the IDER, the process 800 may proceed to the 808 block. If no priority energy allocations are associated to the IDER, the process 800 may bypass the transmission of the notifications and may proceed directly to a 816 block to execute the shutdown of the IDER.

At the 808 block, the VRP may transmit one or more warning notifications to the dependent entities, including energy consumers and energy storage facilities that may be dependent on the IDER. The one or more warning notifications may notify the dependent entities of the impending shutdown and may provide a predefined time to make alternative arrangements to safeguard continuity of operations and minimize disruptions.

Further, at 810 block, the VRP may determine a reception of an override command from the dependent entities in response to the warning notification. If an override command is received, the process 800 may proceed to a 812 block, which may allow for potential adjustments. If no override command is received, the process 800 may proceed directly to the 816 block to carry out the shutdown of the IDER.

At the 812 block, the VRP may evaluate a need for flexibility in the shutdown trigger based on the received override command. The received override command may include a time duration to extend the shutdown of the IDER in favor of the dependent entities, according to an embodiment of the present invention. In such an embodiment of the present invention, the VRP may decide to extend the shutdown trigger to provide an additional time based on the received time duration for ongoing operations or critical preparations. In another embodiment of the present invention, the VRP may be configured to negotiate on the received time duration based on an urgency of the shutdown of the IDERs within a specified time limit.

At 814 block, the VRP may allow the extended shutdown trigger to lapse, following that the IDER shutdown may initiated.

At the 816 block, the VRP may execute the shutdown of the IDER. The shutdown process may executed with measures to enable system safety and may minimize any adverse impact on dependent operations. Furthermore, the status of the IDER may remain in “inactive” to prevent any further linkages or allocations such as the IDER may not participate in any future operations until explicitly reactivated.

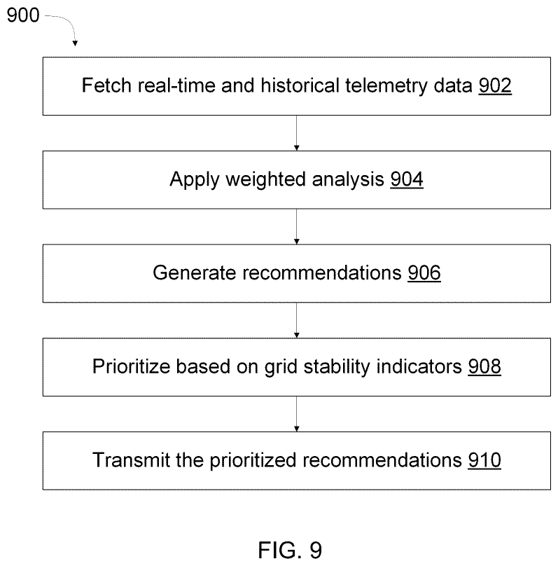

FIG. 9 may be an exemplary process 900 of providing energy management recommendations with prioritization in accordance with at least one embodiment of the present invention.

At 902 block, the VRP may begin by fetching the real-time telemetry data from the one or more of the IDERs using the standardized API. The telemetry data may include metrics such as energy production, energy consumption, and other key performance indicators (KPIs) that may be used for effective energy management.

At 904 block, the VRP may analyze the fetched telemetry data by applying the weighted analysis. By applying the weighted analysis, the VRP may be configured to identify patterns, trends, or anomalies in the performance of the IDERs.

At 906 block, the VRP may generate the one or more energy management recommendations based on the insights obtained from the analyzed telemetry data. The one or more energy management recommendations may include actions such as optimizing energy distribution, reallocating resources, or scheduling maintenance activities for underperforming IDERs.

At 908 block, the VRP may dynamically prioritize the one or more generated energy management recommendations based on one or more grid stability indicators. The prioritization may further be based on the applied weighted analysis that may consider one or more of the real-time telemetry data and historical telemetry data from the virtualization database. Examples of grid stability indicators include criticality of energy loads, operational constraints, system efficiency, and so forth. The VRP may be configured to rank the one or more generated energy management recommendations based on the dynamically prioritization.

At 910 block, the VRP may transmit the one or more prioritized energy management recommendations to the entities of the system for microgrid interfacing including energy operators and the dependent entities. These entities may be notified about the one or more prioritized energy management recommendations to ensure timely action and maintain seamless operations. The VRP may continuously monitor the implementation of the energy management recommendations and their impact on the overall energy operations. If any adjustments are required, the VRP may refine the one or more energy management recommendations and may transmit the updated energy management recommendations, accordingly. The VRP may consolidate outcomes of the implemented one or more energy management recommendations into the virtualization database. This step may enable the VRP to learn and improve its predictive capabilities over time by leveraging historical data and feedback from previous actions.

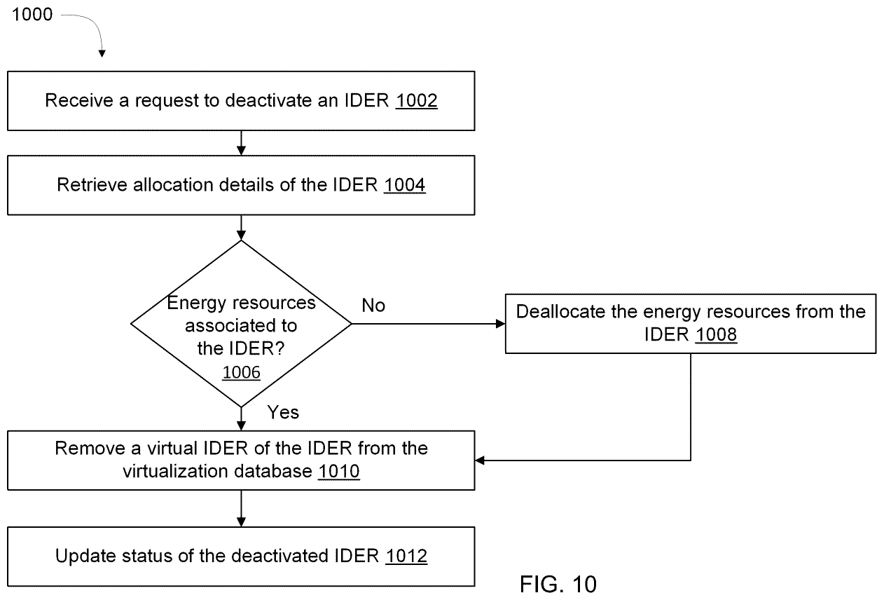

FIG. 10 may be an exemplary process 1000 of deactivating the IDER from the VRP in accordance with at least one embodiment of the present invention.

At 1002 block, the VRP may receive a request to deactivate an Integrated Distributed Energy Resource (IDER). This request may originate from an authorized energy user of the IDER, a system-generated trigger, or a scheduled maintenance command. The request may be validated to ensure that it complies with security protocols and operational guidelines.

At 1004 block, the VRP may retrieve the allocation details of the IDER from the virtualization database based on the received request for deactivation. The retrieved allocation details may include metadata such as the IDER's operational status, current energy output or consumption metrics, and any active resource mappings with the one or more energy consumers. The retrieval of the allocation details may be essential to understand the IDER's connections and dependencies within the distributed energy networks such that no critical operations or services may be inadvertently affected during the deactivation process.

At 1006 block, the VRP may determine whether there may be any energy resources of the one or more energy consumers currently associated with the IDER or not. The energy resources of the one or more energy consumers may include energy storage systems, consumers, or other grid components that rely on the IDER's operations. The VRP may check for active allocations linked to the IDER to determine whether additional steps are required to safely deallocate these resources before the deactivation proceeds.

At 1008 block, if energy resources may be found to be associated with the IDER, the VRP may proceed to deallocate these energy resources. This step may involve redistributing energy flows to alternate sources or disconnecting the associated resources from the IDER in a controlled manner. By enabling linked energy resources to be safely deallocated, the VRP may minimize the risk of disruption to other parts of the grid.

At 1010 block, if no energy resources are associated with the IDER, the VRP may proceed to remove the Virtual IDER representation of the physical IDER to be deactivated from the virtualization database. This removal may involve deleting or forgetting one or more of the unique identifiers of the IDER's, the metadata, and the hierarchical mappings stored in the database corresponding to the IDER. This step ensures that the database accurately reflects the current state of the microgrid and prevents any future operational errors related to the deactivated IDER.

Further, at 1012 block, the VRP may deactivate the IDER upon removal of the virtual IDER representation from the virtualization database. The VRP may update the status of the deactivated IDER with the predictive energy manager. The updated status may indicate that the IDER may be now offline or inactive, confirming that the predictive energy manager and other system components may be aware of the IDER's current state. This status update may also trigger any post-deactivation workflows, such as logging the event for auditing purposes or initiating maintenance activities. By maintaining an accurate and synchronized record of the IDER's status, the predictive energy manager may ensure a reliable management of the microgrid.

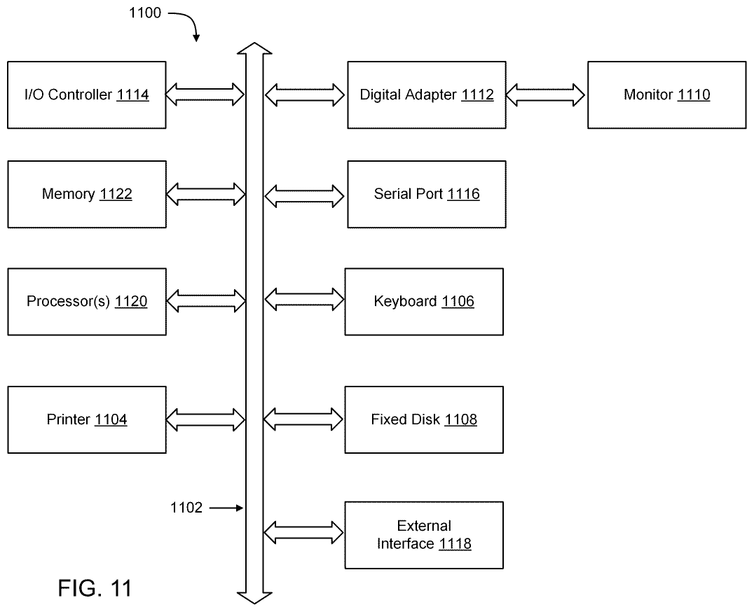

FIG. 11 a schematic diagram illustrating aspects of an example computer in accordance with at least one embodiment of the present invention. In accordance with at least some embodiments, the system, apparatus, methods, processes and/or operations for message coding may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system.

As an example, the FIG. 11 depicts aspects of elements that may be present in a computer device and/or system 1100 configured to implement a method and/or process in accordance with some embodiments of the present invention. The subsystems shown in FIG. 11 are interconnected via a system bus 1102. Additional subsystems such as a printer 1104, a keyboard 1106, a fixed disk 1108, a monitor 1110, which is coupled to a display adapter 1112. Peripherals and input/output (I/O) devices, which couple to an I/O controller 1114, can be connected to the computer system by any number of means known in the art, such as a serial port 1116. For example, the serial port 1116 or an external interface 1118 can be utilized to connect the computer device 1100 to further devices and/or systems not shown in FIG. 11 including a wide area network such as the Internet, a mouse input device, and/or a scanner. The interconnection via the system bus 1102 allows one or more processors 1120 to communicate with each subsystem and to control the execution of instructions that may be stored in a system memory 1122 and/or the fixed disk 1108, as well as the exchange of information between subsystems. The system memory 1122 and/or the fixed disk 1108 may embody a tangible computer-readable medium.

It should be understood that the present invention as described above can be implemented in the form of control logic using computer software in a modular or integrated manner. Alternatively, or in addition, embodiments of the invention may be implemented partially or entirely in hardware, for example, with one or more circuits such as electronic circuits, optical circuits, analog circuits, digital circuits, integrated circuits (“IC”, sometimes called a “chip”) including application-specific ICs (“ASICs”) and field-programmable gate arrays (“FPGAs”), and suitable combinations thereof. As will be apparent to one of skill in the art, notions of computational complexity and computational efficiency may be applied mutatis mutandis to circuits and/or circuitry that implement computations and/or algorithms. Based on the disclosure and teachings provided herein, a person of ordinary skill in the art will know and appreciate other ways and/or methods to implement the present invention using hardware and/or a combination of hardware and software.

Any of the software components, processes or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random-access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for microgrid interfacing, comprising:
at least one request-handling interface configured to receive one or more requests for interfacing of a plurality of integrated distributed energy resources (IDERs) with a virtual resource platform (VRP);
at least one driver identification engine configured to retrieve one or more resource metadata attributes of each of the plurality of IDERs for identifying one or more drivers from at least one drivers database corresponding to the each of the plurality of IDERs;
at least one standardized application programming interface (API) configured to enable interfacing of at least one of the plurality of IDERs through the one or more identified drivers with the virtual resource platform; and
at least one predictive energy manager communicatively connected with the one or more identified drivers of the plurality of IDERs, wherein the at least one predictive energy manager is configured at least to:
fetch telemetry data from individual ones of the interfaced plurality of IDERs; and
generate one or more energy management analysis products based at least in part on the fetched telemetry data.

2. The system of claim 1, wherein the one or more resource metadata attributes include one or more of: a device type, a make, a model, an operational capacity, and supported protocols.

3. The system of claim 1, wherein the telemetry data fetched from at least one of the plurality of IDERs comprises one or more of: key performance indicators (KPIs), state triggers of the plurality of IDERs, energy production metrics, and consumption metrics.

4. The system of claim 1, wherein the virtualization database is further configured to:
store one or more hierarchical mappings of the interfaced plurality of IDERs to corresponding energy resource types; and
store operational failures of each of the interfaced plurality of IDERs by associating one or more failure events within the one or more hierarchical mappings.

5. The system of claim 1, wherein the predictive energy manager is further configured to set at least one minimum threshold for the fetched telemetry data for individual ones of the plurality of IDERs for an analysis of the fetched telemetry data.

6. The system of claim 5, wherein the predictive energy manager is configured to generate at least one error notification when the analyzed telemetry data of one or more of the plurality of IDERs fails to meet the at least one minimum threshold.

7. The system of claim 1, wherein the analysis of the telemetry data of one or more of the interfaced plurality of IDERs is performed at least in part by applying one or more machine-learning-based models to enable a detection of one or more deviations from one or more expected performance benchmarks of the one or more of the interfaced plurality of IDERs.

8. The system of claim 1, wherein the predictive energy manager is further configured to dynamically prioritize the one or more energy management analysis products based on at least one weighted analysis of the telemetry data analyzed in real-time and historical telemetry data of the interfaced plurality of IDERs.

9. The system of claim 1, further comprising a security engine at least configured to enable secure API interactions among the interfaced plurality of IDERs with the virtual resource platform.

10. The system of claim 1, wherein the standardized API is configured to enable a cross-platform compatibility for a plurality of makes and models of the plurality of the IDERs through a middle translation layer.

11. The system of claim 1, wherein one or more of the interfaced plurality of IDERs is deactivated from the virtual resource platform by, at least:
identifying one or more energy resources associated with the one or more of the interfaced plurality of IDERs to be deactivated;
deallocating the one or more of the interfaced plurality of IDERs from the identified one or more energy resources; and
deactivating the one or more of the interfaced plurality of IDERs from the virtualization database.

12. The system of claim 1, wherein the virtual resource platform is configured to enable a soft shutdown or a hard shutdown of the one or more of the interfaced plurality of IDERs based on at least one priority call of one or more allocations associated with the one or more of the interfaced plurality of IDERs.

13. The system of claim 1, further comprising at least one virtualization database configured to store the one or more retrieved resource metadata attributes and at least one unique identifier corresponding to each of the interfaced plurality of IDERs.

14. A method for microgrid interfacing, comprising:
receiving, by at least one request-handling interface of a virtual resource platform (VRP), one or more requests for interfacing a plurality of integrated distributed energy resources (IDERs) with the VRP;
retrieving, by at least one driver identification engine, one or more resource metadata attributes of each of the plurality of IDERs for identifying one or more drivers corresponding to each of the plurality of IDERs from at least one drivers database;
enabling, by at least one standardized application programming interface (API), interfacing of the plurality of IDERs through the identified one or more drivers with the VRP;
fetching, by at least one predictive energy manager communicatively connected with the one or more identified drivers, telemetry data from individual ones of the interfaced plurality of IDERs; and
generating, by the at least one predictive energy manager, one or more energy management analysis products based at least in part on the fetched telemetry data.

15. The method of claim 14, further comprising:
applying machine-learning-based models for an analysis of the telemetry data of one or more of the interfaced plurality of IDERs; and
enabling a detection of deviations from expected performance benchmarks based at least in part on the analysis of the telemetry data.

16. The method of claim 14, further comprising:
storing, by a virtualization database, one or more hierarchical mappings of the interfaced plurality of IDERs to corresponding energy resource types; and
storing operational failures of each of the interfaced plurality of IDERs by associating one or more failure events within the one or more hierarchical mappings.

17. The method of claim 14, further comprising: prioritizing the energy management analysis products based on one or more grid stability indicators.

18. The method of claim 14, further comprising: selecting or setting, by the predictive energy manager, at least one minimum threshold for the fetched telemetry data for each of the plurality of IDERs to ensure consistent analysis of the telemetry data.

19. The method of claim 18, further comprising generating, by the predictive energy manager, at least one error notification when the analyzed telemetry data of one or more of the plurality of IDERs fails to meet the at least one minimum threshold.

20. The method of claim 14, further comprising enabling a cross-platform compatibility for a plurality of makes and models of the plurality of the IDERs through a middle translation layer.

21. The method of claim 14, further comprising storing, by at least one virtualization database, the retrieved one or more resource metadata attributes and at least one unique identifier corresponding to each of the interfaced plurality of IDERs.

22. One or more computer-readable storage media collectively having thereon computer-executable instructions that, when executed, collectively cause one or more computers to, at least:
receive, by at least one request-handling interface of a virtual resource platform (VRP), one or more requests for interfacing a plurality of integrated distributed energy resources (IDERs) with the VRP;
retrieve, by at least one driver identification engine, one or more resource metadata attributes of each of the plurality of IDERs for identifying one or more drivers corresponding to each of the plurality of IDERs from at least one drivers database;
enable, by at least one standardized Application Programming Interface (API), interfacing of the plurality of IDERs through the identified one or more drivers with the VRP;
fetch, by at least one predictive energy manager communicatively connected with the one or more identified drivers, telemetry data from each of the interfaced plurality of IDERs; and
generate, by the at least one predictive energy manager, one or more energy management analysis products by analyzing the fetched telemetry data.
